(19) United States
(12) Patent Application Publication
(10) Pub. No.: US 2026/0292510 A1
(43) Pub. Date: Sep. 24, 2026

(54) HOSTILE DEVICE DETECTION SYSTEM AND METHODS FOR SECURE SPACE PROTECTION

(71) Applicant: NORTHROP GRUMMAN SYSTEMS CORPORATION, Falls Church, VA (US)

(72) Inventors: Peter B. Houser, Poway, CA (US); Michael P. Johnson, Poway, CA (US)

(73) Assignee: NORTHROP GRUMMAN SYSTEMS CORPORATION, Falls Church, VA (US)

(21) Appl. No.: 19/086,438

(22) Filed: Mar. 21, 2025

(51) Int. Cl. H04W 12/122; H04B 17/309; H04W 16/18

(52) U.S. Cl. CPC H04W 12/122; H04B 17/309; H04W 16/18

(57) ABSTRACT

The hostile device detection system (HDDS) is installed and operated within a sensitive space boundary. The HDDS is calibrated using known devices and equipment and the capabilities of the known devices are recorded. From this calibration, a pattern of life (PoL) can be established. The HDDS monitors for any deviations from the PoL in order to detect hostile devices within the sensitive space boundary. The HDDS can also pinpoint the location of the hostile devices to make their locating and removal easier for personnel.

### FIELD OF THE INVENTION

The present invention relates to a hostile device detection system (HDDS) used to detect and locate hostile devices and/or unauthorized devices within a sensitive space boundary.

### BACKGROUND

Military and civilian organizations often desire to control and limit radio frequency (RF) signals (or other signals) that are generated within an area from user devices, hostile devices, power control systems, etc. Currently, hostile devices (encompassing unauthorized user devices) are generally detected by monitoring signals within the sensitive space boundary. If any hostile signals are detected, dedicated staff must often meticulously search the sensitive space boundary for the hostile devices. This can be time consuming and difficult, especially since hostile devices can take many forms and even be mobile (e.g., an unauthorized cell phone). Many military and commercial organizations operate Sensitive Compartmented Information Facilities (SCIFs) that incorporate a Faraday cage to help prevent eavesdropping, but hostile devices within the SCIF may still be able to collect data and transmit it later when outside the SCIF or otherwise bypass the SCIF’s protections. Therefore, a need exists for a HDDS that allows hostile devices to quickly be located and identified within a sensitive space boundary. This need may also be present in other sensitive spaces that may be subject to eavesdropping, e.g., the board room for a large company.

### SUMMARY

The hostile device detection system (HDDS) is installed and operated within a sensitive space boundary. The HDDS is calibrated using known devices and equipment and the capabilities of the known devices are recorded. From this calibration, a pattern of life (PoL) can be established. The HDDS monitors for any deviations from the PoL in order to detect hostile devices within the sensitive space boundary. The HDDS can also pinpoint the location of the hostile devices to make their locating and removal easier for personnel.

### BRIEF DESCRIPTION OF THE DRAWINGS

FIG. 1 depicts a system diagram showing the HDDS used to establish or enhance a sensitive space boundary according to an embodiment of the invention.

FIG. 2 highlights the components of FIG. 1 involved in power monitoring and distribution according to an embodiment of the invention.

FIG. 3 highlights the components of FIG. 1 involved in sensitive space administration and user operation according to an embodiment of the invention.

FIG. 4 highlights the components of FIG. 1 involved in setup and calibration according to an embodiment of the invention.

FIG. 5 highlights the components of FIG. 1 involved in hostile device detection operations according to an embodiment of the invention.

FIG. 6 depicts example components of a digital antenna according to an embodiment of the invention.

FIG. 7 depicts example components of the power monitoring and distribution system according to an embodiment of the invention.

FIG. 8 depicts example components of the SADS used for creating virtual channels according to an embodiment of the invention.

FIG. 9 depicts an example setup of transmitters and receivers used for setup and calibration within a sensitive space boundary according to an embodiment of the invention.

FIG. 10 depicts a software defined radio according to an embodiment of the invention.

FIG. 11 depicts a flowchart showing the steps used for setup and calibration of the hostile device detection system according to an embodiment of the invention.

FIG. 12 depicts a flowchart showing the steps used for hostile device detection according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

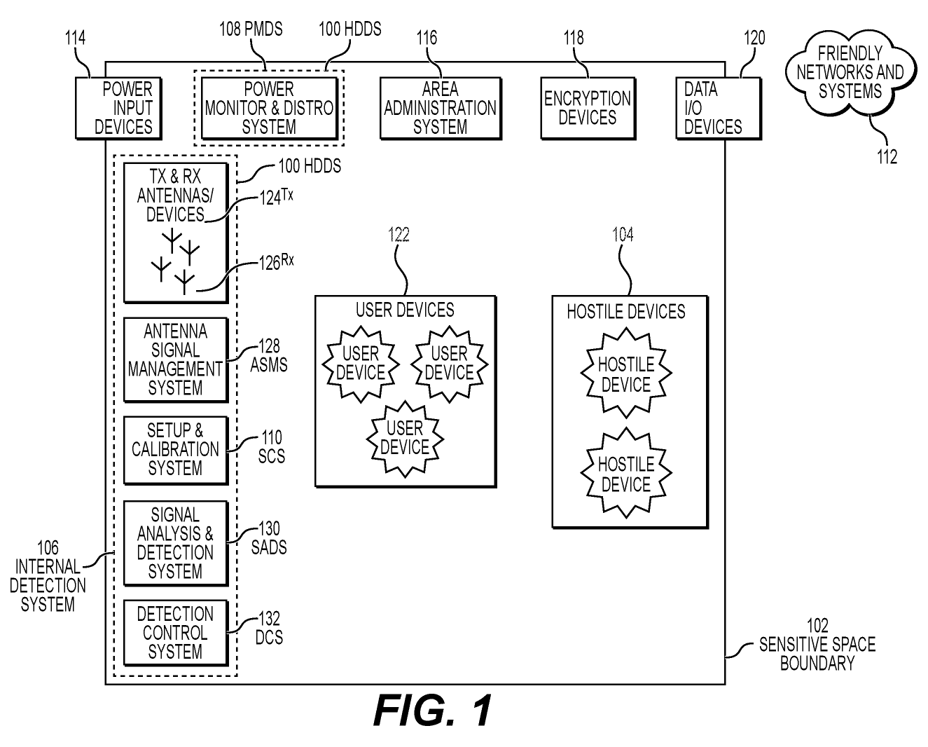

FIG. 1 depicts a system environment of HDDS 100 which operates within or monitors a sensitive space boundary 102 (e.g., corresponding to the boundary of a SCIF). As previously discussed, most prior art solutions for detection within sensitive space boundaries 102 involve individuals utilizing electronic equipment to actually search and locate hostile devices suspected within sensitive space boundary 102. The HDDS 100 of the present invention can be used within any type of sensitive space boundary 102 to detect hostile devices 104, such as a SCIF with a Faraday Cage, or in an open environment.

Generally, HDDS 100 comprises internal detection system (IDS) 106 and power monitor and distribution system (PMDS) 108. The use of the term “internal” in IDS 106 refers to the intended or predetermined boundaries of sensitive space boundary 102 and not to a physical location of the internal detection system 106. Generally, within a SCIF or other sensitive space boundary 102, a plurality of other systems or components also operate which may include, but are not limited to, power input devices 114, area administration system 116, encryption devices 118, data I/O devices 120, user devices 122, and hostile devices 104 (to be detected by HDDS 100). The difference between user devices 122 and hostile devices 104 will be explained later. Power input devices 114, area administration system 116, encryption devices 118, and data I/O devices 120 are “trusted” components that do not (necessarily) require detection and the HDDS 100 provides multiple functions related to sensitive space administration and user operation.

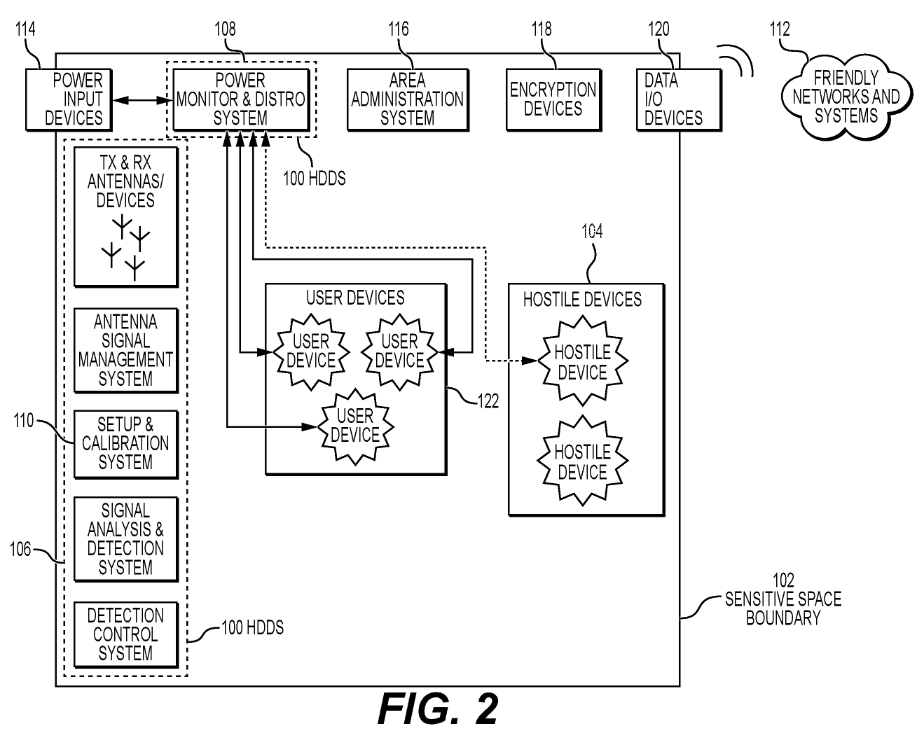

As depicted in FIG. 2, the area administration system 116 and encryption devices 118 are “trusted” so their power and ground characteristics do not require monitoring. However, PMDS 108 monitors all other power supplied throughout sensitive space boundary 102 such as power from power input devices 114 and power to user devices 122 or hostile devices 104. Accordingly, PMDS 108 comprises its own detection system for detecting any unauthorized power usage or signals that may be propagated over components of the power system, such as power lines or power supplied to user devices 122 or hostile devices 104.

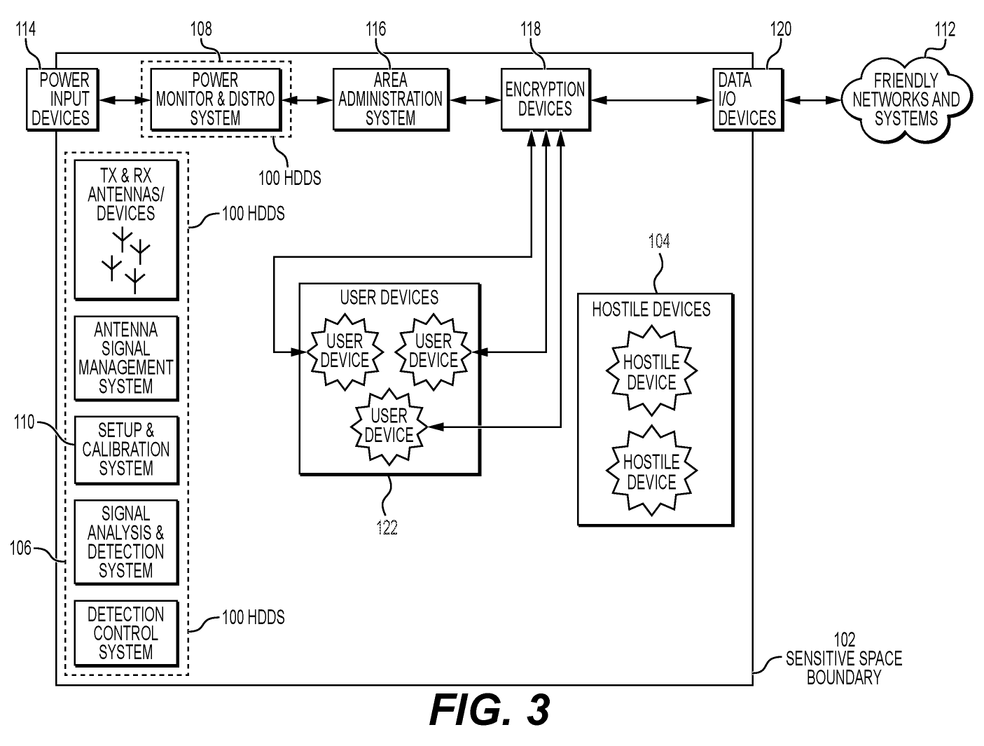

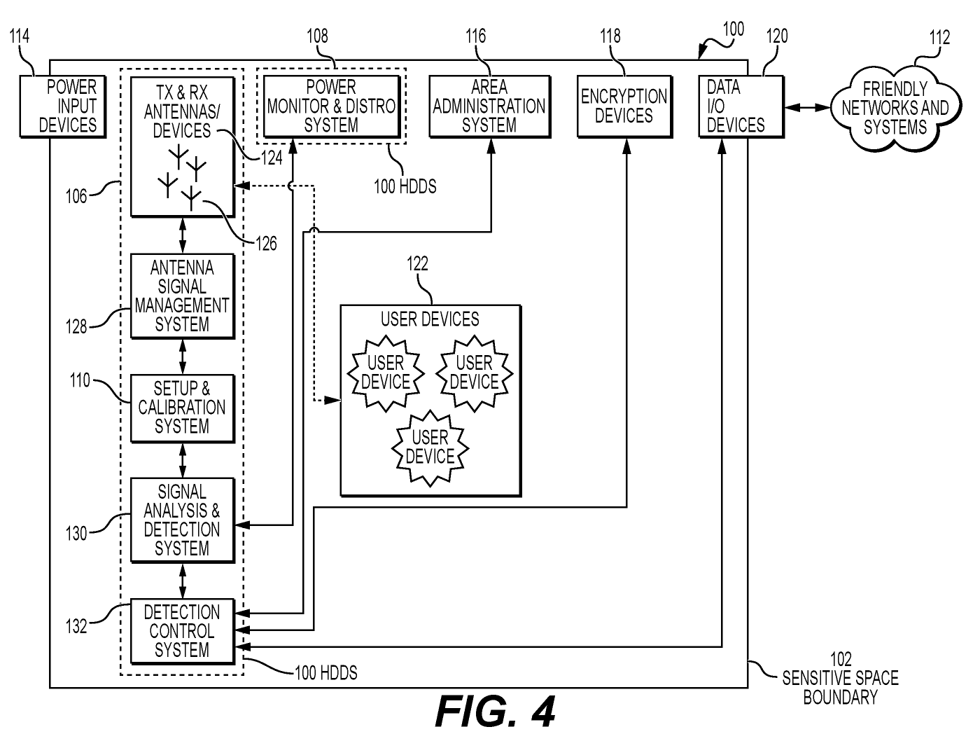

The HDDS 100 further monitors user devices 122 to ensure compliance with any local rules and to ensure proper RF emission levels within (or external to) sensitive space boundary 102 are not exceeded as depicted in FIG. 3. Compliance verification and recording (e.g., for security, regulatory, and safety) may be performed by detection control system 132 depicted in FIG. 4. Different alarms might be inherent or dedicated. Access to many components of HDDS 100 might be privileged or restricted to different levels of access as is known in the art.

HDDS 100 may be deployed in a variety of settings including:

within a permanent sensitive space facility (SCIF) to provide additional protection

or to meet evolving certification requirements;

within a permanent but currently unprotected space;

for transitory needs, e.g., battleforce on the move, flightline operations; and

large spaces (e.g., an airport hangar) might need several EMSs 100.

Encryption devices 118 may include one or more High Assurance Internet Protocol Encryptors (HAIPE) for encrypting all communication exchanged between friendly networks and systems 112 and user devices 122.

As depicted in FIG. 4, setup and calibration of the various components of HDDS is primarily conducted using setup and calibration system (SCS) 110 which is a component of internal detection system 106. Internal detection system 106 generally comprises transmit antenna(s) 124, reception antenna(s) 126, antenna signal management system (ASMS) 128, SCS 110, signal analysis and detection system (SADS) 130, and detection control system (DCS) 132. SCS 110 utilizes transmit antennas 124 and reception antennas to ensure that the entirety of sensitive space boundary 102 can be monitored for hostile devices 104 (e.g., so there are no “dead” detection areas) and determines the optimal placement of transmit antennas 124 and reception antennas 126 for optimal coverage. Further, SCS 110 may regularly recalibrate or reevaluate the positioning of transmit antennas 124 and reception antennas at different intervals or in response to a user instruction because of changes within sensitive space boundary 102 such as additional user devices 122, change in characteristics (e.g., based on age) of transmit antennas 124 and reception antennas 126, or to utilize newer equipment. SCS 110 utilizes data gathered from SADS 130 when performing setup and calibration.

### User device 122 characteristics

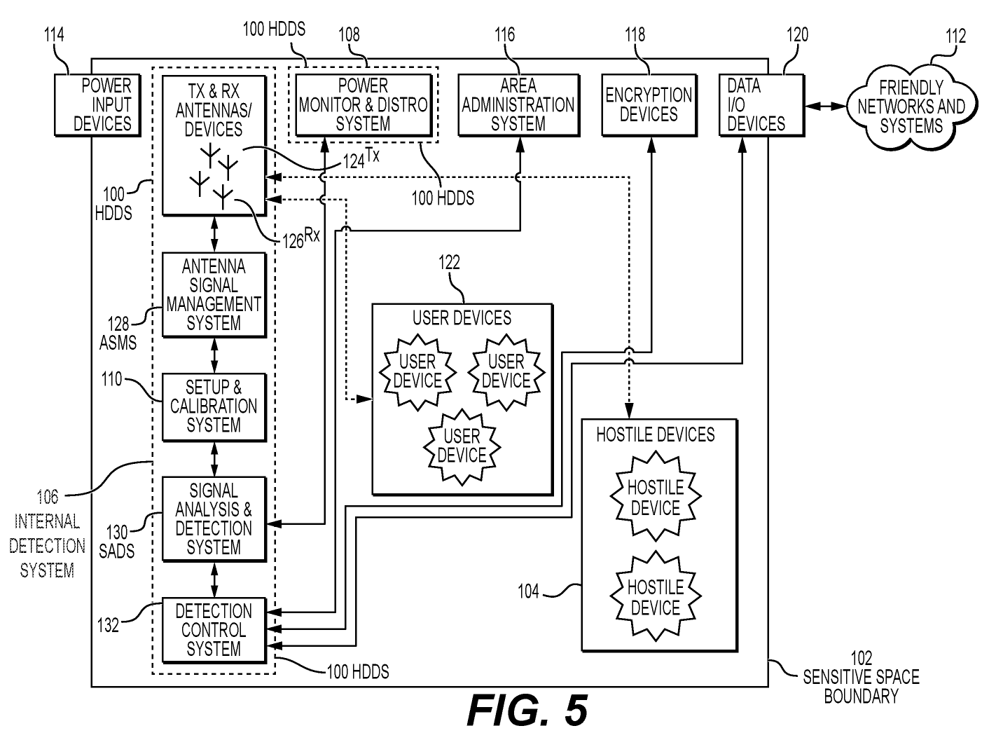

As used herein, “user devices” 122 encompasses all components placed within the sensitive space boundary 102 that are not included within the Administration or HDDS 100. In FIG. 5, user devices 122 may include:

all types of cables and connectors;

all information processing systems;

all information storage systems or devices; and

all personal electronic devices

In a preferred embodiment, all user devices 122 are evaluated and approved before placement within the sensitive area. The RF and power characteristics of each user device 122 are measured, analyzed, and characterized before operation so any anomalies with user devices 122 can be detected more easily. User devices 122 may also be regularly reevaluated since operational characteristics can change over time as user devices 122 age. The MAC address, or other unique identifier, of each user device 122 may be used to track the devices on any wired or wireless networks within sensitive space boundary 102.

User device 122 emissions will often correspond to known components within the devices and those component’s emissions characteristics. Detection techniques from HDDS 100 may be specific to hostile devices 104 or may be generically relevant to classes of user devices 122. For example, the detection techniques may depend upon the network capabilities of the user device (e.g., 4G, 5G, BT, Wi-Fi, etc.).

### Hostile device 104 characteristics

In FIG. 5, “hostile devices” 104 encompasses all components that are present within the sensitive space without authorization, including but not limited to:

Devices that are introduced by an adversary (“always red”).

Devices that are (inadvertently) introduced by users.

User devices that are operating in an unauthorized manner.

“Blue” devices that are operating differently than authorized.

Devices that acquire information using unauthorized wired or wireless connections to user devices 122.

Devices that transmit information for outside reception (transmission may be via power lines, RF, magnetics, or others).

Devices that store information for subsequent retrieval.

Devices that interfere with approved user device operation.

Hostile devices 104 may be self-powered or may use facility power from PMDS 108, for example. Hostile devices 104 may be physically and operationally covert.

### Transmit antennas 124 and reception antenna 126 characteristics

The following description may apply to transmit antennas 124 and reception antennas 126 utilized either generally within internal detection system 106 or specifically within SCS 110. The reception antennas 126 are utilized to sense RF emissions from the user devices 122. The received signals are then digitized and analyzed to determine one or more hostile devices 104 using detection techniques. Transmit antennas 124, in turn, may be used to help identify the location of any detected hostile devices 104. The individual antennas within internal detection system 106 may be reception antennas, transmit antennas, or a combination thereof.

The antennas 124 and 126 for internal detection system 106 or SCS 110 are selected for response in the bands that correspond to emissions of the known user devices 122 and the anticipated hostile devices 104 within sensitive space boundary 102. The antennas 124 and 126 may incorporate conventional analog designs or digital radioheads (including A/D, D/A, LNA (low-noise amplifier), PA (power amplifier), Rx (reception) filtering, and Tx (transmission) filtering). Antennas for internal detection system 106 may be placed throughout the sensitive space boundary 102 in order to ensure a strong RF path to/from each user device 122 and potential hostile device 104. Antennas 124 and 126 may have differing characteristics in order to address all reception and transmission needs for all device 122 and 104 emissions. The antenna suite may be simple, or it may be complex in order to effectively detect a large variety or number of hostile devices 104.

The antennas 124 and 126 may be mobile antennas that can be moved. For example, antennas 124 and 126 may be on the ground, in the air, crawling the walls or ceiling, etc. SCS 110 may order antennas 124 and 126 to a new location in order to improve detection or localization of hostile devices 104.

### PMDS 108 characteristics

The PMDS 108 accepts power from an appropriate (e.g., monitored) source and distributes “clean power” to other components within the sensitive space boundary 102. The PMDS 108 also provides “clean” grounding to other components in the sensitive space boundary 102. In particular, the PMDS 108 segregates the power and ground lines for each user device 122 or group of user devices 122 and monitors the characteristics of each power line. The PMDS 108 mitigates power and ground emissions by emitting power signals onto corresponding power and ground lines. The PMDS 108 exchanges data and alarms with the SADS 130. In some embodiments, the PMDS 108 may cut power to selected user devices 122 in order to reduce the RF clutter within sensitive space boundary 102 and improve detection of hostile devices 104.

### ASMS 128 characteristics

The ASMS 128 exchanges signals with each antenna 124 or 126 in internal detection system 106. The antenna signals may be analog (conventional antenna) or digital (digital radiohead). Digital antenna connections may be networked. In a preferred embodiment, fiber optics are used when possible for communication within sensitive space boundary 102.

The ASMS 128 exchanges digital signals with SADS 130, preferably using an open standard such as VITA 49.2 or equivalent commercial standards. When using conventional antennas, the ASMS 128 provides A/D, D/A, LNA, PA, Rx filtering, and Tx filtering. The ASMS 128 isolates the rest of the system within internal detection system 106 from any analog signals. Digital radioheads may provide some of the required A/D, D/A, LNA, PA, Rx filtering, and Tx filtering capabilities.

In some embodiments, the ASMS 128 may provide signal manipulation including time shifting and/or combining channels and MIMO methods to address multipath transmission paths. Such signal manipulation creates a more focused synthetic channel that may enhance signal reception and/or transmission quality and utility. ASMS 128 also controls movements of mobile antenna devices 124 and 126 as directed.

### SCS 110 characteristics

SCS 110 exchanges digital signals with other components to characterize and optimize the RF surveillance coverage across the entire sensitive space boundary 102. The SCS 110 determines/maintains the current and/or previous location of each antenna 124 or 126 in a historical database.

The SCS 110 may use amplitude-based detection, Time Difference of Arrival (TDOA), or other methods to determine the location of each transmit antenna 124 or reception antenna 126. Some antennas 124 or 126 may be manually located or positioned within sensitive space boundary 102 and then used as datums for others.

The SCS 110 may determine or maintain propagation characteristics of each transmit antenna 124 and/or reception antenna 126 with each receiver, such as user devices 122 (e.g., delay, loss, distortion, multi-path). During system setup and calibration, the SCS 110 determines the system coverage across the entire sensitive space boundary 102 and recommends adjustments such a repositioning of antennas 124 or 126 or the addition/removal of certain devices within sensitive space boundary 102. During system calibration, the SCS determines propagation characteristics of each RF path between devices within sensitive space boundary 102 and determines/maintains associated signal processing tuning parameters.

### SADS 130 characteristics

The SADS 130 exchanges digital signals with other components of HDDS 100 to characterize the baseline RF & Power “Pattern of Life” (PoL) within the sensitive space boundary 102 and to detect unauthorized emissions from hostile devices 104 within that context. PoL may be computed globally (across all sensors/antennas) or piecewise (across groups of sensors/antennas, potentially with MIMO or beamforming or other methods to isolate/amplify signals and regions). Conceptually the SADS 130 comprises many “detection channels”, each of which may be implemented within a Software Defined radio (SDR) 1002.

The detection channels implement “detection techniques”, i.e., algorithms that detects a specific emission within the context of a specific group of sensors and their PoL. Each detection channel is connected to one or more sensing channels, i.e., synthetic RF created by aggregating signals from one or more sensors. Further, each detection channel applies one or more detection techniques to one or more sensing channels in order to detect a specific emission.

### DCS 132 characteristics

The DCS 132 exchanges control information with components of internal detection system 106 in order to configure it for the intended operations. The DCS 132 exchanges alarms and other emissions status information with SADS 130.

The DCS 132 monitors the overall level of detection coverage across the sensitive space boundary 102 based upon the sensor configuration, the ASMS 128 configuration, the SCS 110 processing, and the SADS 130 configuration as depicted in FIG. 5. The DCS 132 exchanges alarms and other emissions status information with the SADS 130.

The DCS 132 configures the HDDS 100 to address considerations such as:

Adversary situation

Authorized mitigation or detection techniques

Legal requirements

Radiation safety level & calibration requirements

Allow / deny lists

Mission data set

Power, BIT, self-test, and calibration orders

### Transmit antennas 124 and reception antenna 126 details and operation

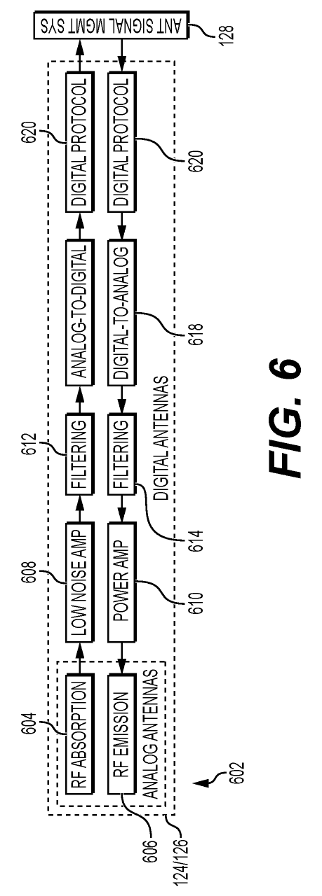

Preferably, the design of sensitive space boundary 102 avoids metallic cabling since that introduces emissions risks and can be hard to route in a secured space. In some embodiments, digital RF antennas with fiber optic connections and/or Bluetooth connections are preferred to avoid any signals from being intercepted. FIG. 6 depicts an example schematic of the components of a digital antenna 602 that can be used as a transmit antenna 124 or reception antenna 126. As shown, digital antenna may comprise analog reception antenna 604, analog transmission antenna 606, low noise amplifier 608, power amplifier 610, reception filters 612, transmission filters 614, A/D convertor 616, D/A converter 618, and digital protocol 620 for communicating with ASMS 128. If analog antennas are utilized, the components 508-520 may be provided by ASMS 128 directly to digitize the RF signals.

A/D convertor 616 and D/A convertor 618 may comprise modulation/demodulation and other signal manipulations and conversions. The analog reception antenna 604 or analog transmission antenna 606 may be omnidirectional (whip) or directional (horn) in order to isolate and amplify signals from specific user devices 122 or hostile devices 104. The ASMS 128 maintains the antenna locations, orders them to new locations, and performs signal processing to combine signals from sets of antennas to create virtual antenna channels.

### PMDS 108 details and operation

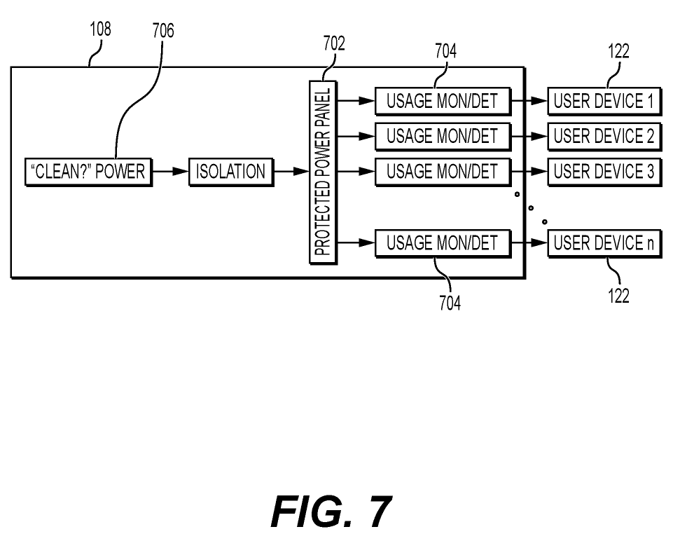

Generally, access to internal power within sensitive space boundary 102 is through one or more protected power panels 702 coupled to usage monitor and detection system 704. As depicted in FIG. 7, clean power is received from power source 706 by PMDS 108 which isolates and distributes power through protected power panels 702. Each port (e.g., plug, USB port, etc.) associated with protected power panel 702 comprises a usage monitor 704 which monitors all power to/from user devices 122.

The usage monitors 704 will monitor power usage and provide inputs to the SADS 130 to determine the power PoL and to detect anomalous power usage that indicates a hostile device 104. Further, usage monitors 704 connect to the SADS 130 using methods similar to those used for antennas 124 and 126. Similar architecture is used for both power and for ground(s) for power source 706. Several similar power or ground distribution networks 702 and 704 can be used to improve isolation.

### ASMS 128 details and operation

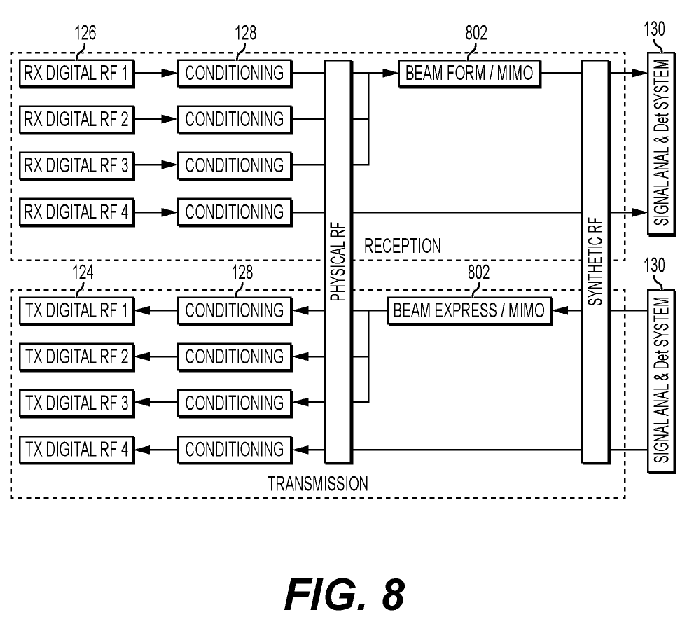

The ASMS 128 exchanges synthetic RF with the SADS 130 and exchanges physical RF with the transmit antennas 124 and reception antennas 126. Beamforming and/or Multiple-In, Multiple Out (MIMO) techniques are used to create the virtual channels 802 as depicted in FIG. 8. The RF signals received by reception antennas 126 are conditioned (after being digitized) by ASMS 128 before being arranged into virtual channels 802 which are communicated to SADS 130. Similarly, outgoing synthetic RF signals from SADS are split, conditioned by ASMS 128, and then sent to different transmit antennas 124. The ASMS 128 controls antenna movements in response to orders received from the DCS 132.

### SCS 110 setup and calibration

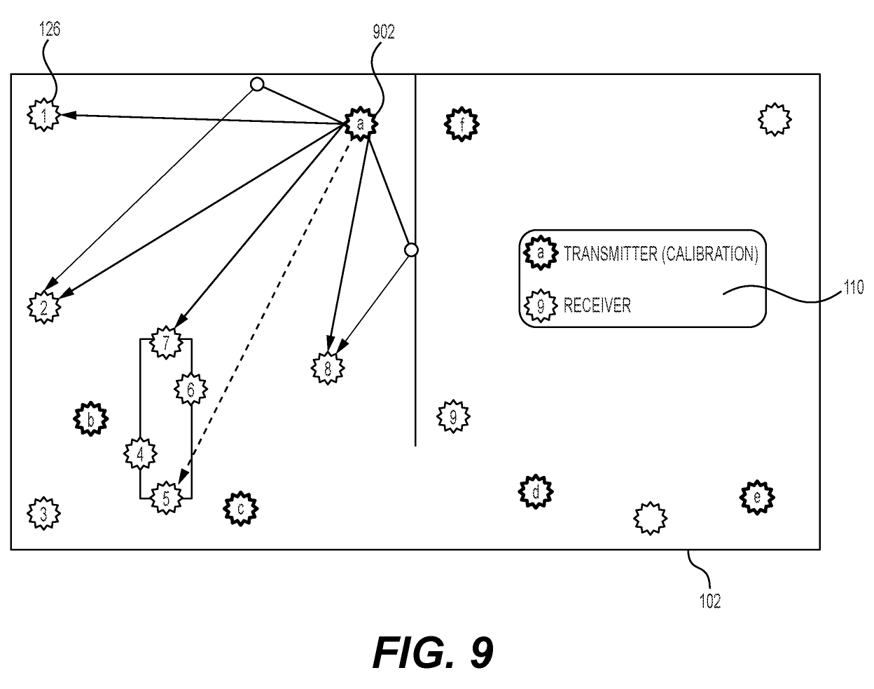

When the sensitive space boundary 102 is initially established, SCS 110 performs a setup and calibration routine to map the sensitive space boundary. SCS 110 use reception antennas 126 with dedicated calibration transmission antennas 902 as depicted in FIG. 9. The setup process determines the path and path loss between each calibration transmission antenna 902 and each reception antenna 126. These transmitted signals may also be used to determine each reception antenna 126 location as well to determine if a reception antenna 126 is later moved intentionally or inadvertently. The setup process also determines the reception coverage over the entire sensitive space boundary 102 (e.g., for the RF spectrum). The calibration transmission antennas 902 may be mobile and may be ordered to cover specific portions of the sensitive space boundary 102 (e.g., different zones).

The setup signal analysis may be performed on processing hardware that is also used for signal analysis and detection in SADS 130. The setup process may evaluate the quality of the space coverage and may prompt the user to install additional reception antennas 126 to improve coverage. The SCS 110 may reconfigure and recalibrate itself periodically.

### SADS 130 signal analysis and detection details

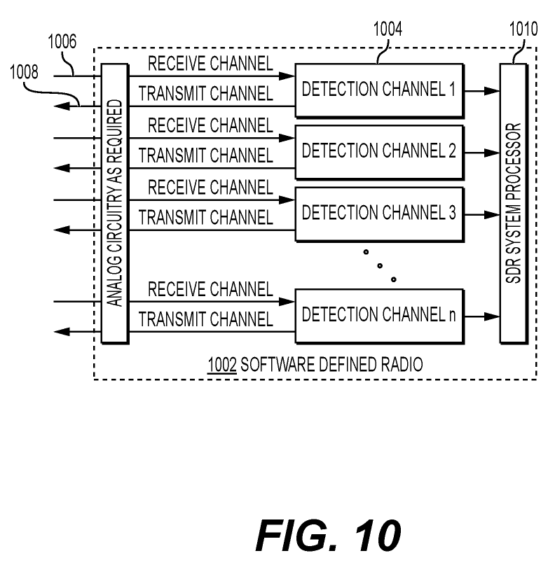

SADS 130 utilizes one or more SDRs 1002 to perform signal analysis and detection. A system diagram of an example SDR 1002 is depicted in FIG. 10. Each detection channel 1004 within SDR 1002 is configured to provide a different type of detection analysis to the receive channel 1006 and/or transmit channel 1008. The SDR system processor 1010 hosts and coordinates detection channels 1004 and detection technique assignments. The SDR system processor 1010 further exchanges commands and status with the DCS 132.

The SDR 1002 may provide circuitry that supports both analog and digital antennas. Each detection channel 1004 continuously characterizes the Pattern of Life (PoL) on the virtual antenna channel data. Each detection channel 1004 implements detection techniques on a virtual antenna channel in the context of the PoL.

The SDR system processor 1010 coordinates detection channel assignments. The PoL process may be based upon statistical or AI methods or a synthesis of methods as is known in the art. The detection process for each detection channel 1004 may be based upon statistical methods, AI methods, or a synthesis of methods.

Synthetic detection channels may be created to better localize a detected hostile device 104. The transmit channels in each Detection Channel may be used to convey calibration transmit signals to calibration transmission antennas 902 during the setup and calibration process by SCS 110.

### DCS 132 details and operation

Generally, the hardware utilized for DCS 132 is determined by the requirements of sensitive space boundary 102. For example, for smaller sensitive space boundaries, a single server or blade server may be suitable whereas larger sensitive space boundaries 102 may require more processing power. Preferably, DCS 132 requires privileged access and/or a dedicated workstation. In some embodiments, DCS 132 may display a diagram of the space coverage and locations of all hardware within HDDS 100, similar to FIG. 9. The diagram can be used to instruct how reception antennas 126 should be positioned to change coverage.

DCS 132 accepts and handles detection events from the SADS 130. Handling may include logging and alerting the operator. Further, DCS 132 may include features to help the operator physically locate an unobtrusive hostile device 104. For example, any hostile devices 104 that are detected may be shown on the diagram of the space coverage to assist in locating the hostile device(s) 104.

DCS 132 may include features to selectively apply and remove power from some of the friendly systems such as area administration system 116 or data I/O devices 120 to better determine the PoL and to detect hostile devices 104.

Compliance verification and recording (e.g., for security, regulatory, and safety) might be inherent in the system or might be addressed in dedicated redundant systems. Access to many system components might be privileged.

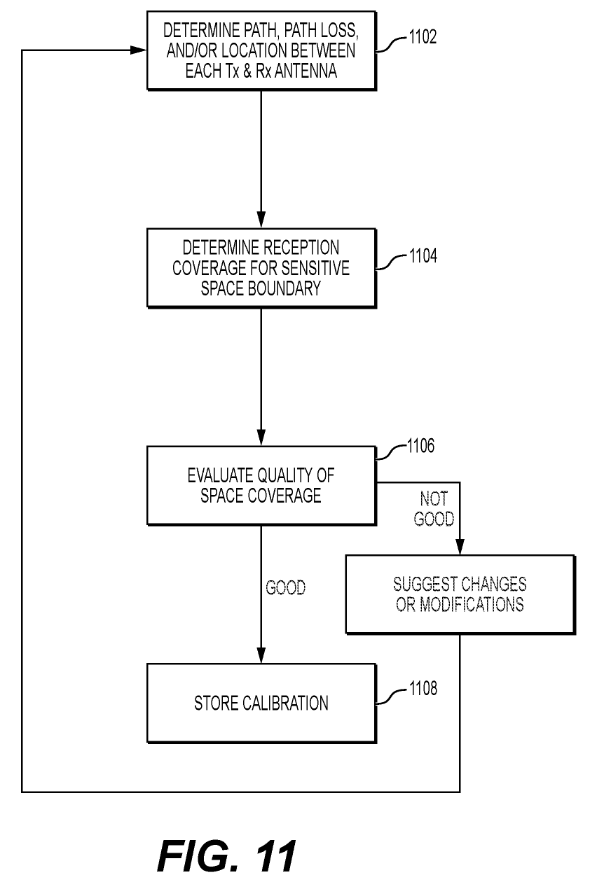

FIG. 11 depicts a flowchart showing the steps used for setup and calibration of the HDDS 100 by SCS 110 after the initial placement of hardware within sensitive space boundary 102 as depicted in FIG. 1. First, the path, path loss, and/or location between each transmit antenna 124 and reception antenna 126 are determined in step 1102 using calibration transmission antennas 902 as previously discussed. The location information is stored and updated by SCS 110 after each calibration and prior locations may be maintained in a historical database. Next, SCS 110 determines the reception coverage of sensitive space boundary 102 in step 1104 to create a coverage map. The coverage map is evaluated in step 1106 to determine the quality of the coverage of sensitive space boundary 102. If the coverage is acceptable, the calibration information is stored and the calibration process is terminated. Alternatively, if the coverage is not acceptable, SCS 110 suggest changes or modifications such as relocating antennas 124 or 126, tuning the antennas, and/or the addition or removal of antennas or other equipment. In some embodiments, the calibration steps 1102-1106 may be conducted with one or more components of HDDS 100 switched off or deactivated to minimize interference.

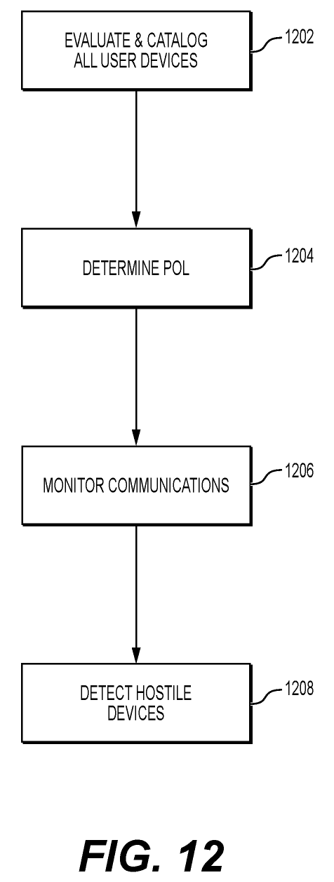

FIG. 12 depicts a flowchart showing the steps used for detection of hostile devices 104. In order to more easily detect hostile devices 104, the characteristics of all devices within sensitive space boundary 102 are evaluated and cataloged in step 1202. For example, a user device 122 that is a smartphone may have its RF capabilities (range and frequency) evaluated so that deviations are easier to detect. Step 1202 may be performed at different intervals since the characteristics of electronic devices may change over time, causing them to inadvertently be identified as hostile devices 104.

The PoL is then determined by SADS 130 in step 1204 as previously described. This establishes a “baseline” for sensitive space boundary 102 so that any deviations from the PoL can more easily be detected. The PoL may be regularly reevaluated and updated as user devices 122 are introduced or removed or as equipment ages. DCS 132 monitors communications in relevant bands and modulations within sensitive space boundary 102 in step 1206. A variety of detection techniques may be employed as has been discussed.

Hostile devices are detected by monitoring for changes to the operational baseline that indicate a hostile device 104, such as deviations from the PoL. Hostile devices 104 can be localized and classified in step 1208 based upon the noted deviations or other factors. Mitigation techniques may also be utilized to disrupt hostile devices 104.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A hostile device detection system (HDDS) for protecting a sensitive space boundary, the HDDS comprising:
a plurality of reception antennas;
a plurality of transmit antennas;
an antenna signal management system (ASMS) for creating virtual antenna channels using the plurality of reception antennas and the plurality of transmit antennas;
a setup and calibration system (SCS) for determining propagation characteristics between each of the plurality of reception antennas, each of the plurality of transmit antennas, and any user devices within the sensitive space boundary to create a system coverage map;
a signal detection and analysis system (SADS) for determining a RF pattern of life (PoL) within the sensitive space boundary,
wherein the SADS compares the system coverage map to the RF PoL to detect any hostile devices within the sensitive space boundary, and
wherein the SADS transmits a notification to at least one user of the HDDS whenever any hostile devices are detected.

2. The HDDS according to claim 1, further comprising:
a power monitor and distribution system (PMDS) for providing power and monitoring power usage within the sensitive space boundary,
wherein the PMDS transmits the monitored power usage to the SADS for determining a power PoL.

3. The HDDS according to claim 2,
wherein the SADS compares the monitored power usage to the power PoL to determine any anomalous power usage within the sensitive space boundary, and
wherein the SADS transmits an alarm to the at least one user whenever anomalous power usage is detected.

4. The HDDS according to claim 1, wherein the SADS updates the RF PoL at predetermined timings or in response to a request from the at least one user.

5. The HDDS according to claim 1,
wherein the SADS comprises a plurality of detection channels, and
wherein a RF PoL is determined for each of the plurality of detection channels.

6. The HDDS according to claim 1, further comprising:
a plurality of calibration transmission antennas,
wherein the SCS utilizes the plurality of calibration transmission antennas to determine a path and a path loss between each of the plurality of transmit antennas and each of the plurality of reception antennas.

7. The HDDS according to claim 6, wherein the SCS utilizes the plurality of calibration transmission antennas to determine a location of each of the plurality of transmit antennas and each of the plurality of reception antennas.

8. The HDDS according to claim 1, wherein an RF range and an RF frequency of any user devices within the sensitive space boundary are evaluated by the SCS during calibration and stored in a user device database.

9. The HDDS according to claim 8, wherein the SCS reevaluates the user devices within the sensitive space boundary at predetermined timings to update the user device database.

10. The HDDS according to claim 1, wherein hostile devices include any unauthorized devices in the sensitive space boundary not included in the user device database.

11. The HDDS according to claim 1,
wherein the SCS evaluates the system coverage map for dead zones, and
wherein the SCS provides instructions to the at least one user to remediate any dead zones.

12. The HDDS according to claim 11,
wherein the instructions include a relocation position for at least one transmit antenna from the plurality of transmit antennas or a relocation position for at least one reception antenna from the plurality of reception antennas.

13. The HDDS according to claim 1,
wherein the SCS evaluates a quality of the system coverage map, and
wherein the SCS provides remediation instructions to the at least one user if the quality is below a predetermined threshold.

14. The HDDS according to claim 1, wherein the notification includes an area or a position within the sensitive space boundary of a detected hostile device.

15. A non-transitory computer readable medium having stored thereon a program for operating a hostile device detection system (HDDS) for protecting a sensitive space boundary, the program comprising:
an antenna signal management system (ASMS) for creating virtual antenna channels using a plurality of reception antennas and a plurality of transmit antennas;
a setup and calibration system (SCS) for determining propagation characteristics between each of the plurality of reception antennas, each of the plurality of transmit antennas, and any user devices within the sensitive space boundary to create a system coverage map;
a signal detection and analysis system (SADS) for determining a RF pattern of life (PoL) within the sensitive space boundary,
wherein the SADS compares the system coverage map to the RF PoL to detect any hostile devices within the sensitive space boundary, and
wherein the SADS transmits a notification to at least one user of the HDDS whenever any hostile devices are detected.

16. A method for operating a hostile device detection system (HDDS) to protect a sensitive space boundary, the method comprising:
by an antenna signal management system (ASMS), creating virtual antenna channels using a plurality of reception antennas and a plurality of transmit antennas;
by a setup and calibration system (SCS), determining propagation characteristics between each of the plurality of reception antennas, each of the plurality of transmit antennas, and any user devices within the sensitive space boundary to create a system coverage map;
by a signal detection and analysis system (SADS), determining a RF pattern of life (PoL) within the sensitive space boundary;
comparing the system coverage map to the RF PoL to detect any hostile devices within the sensitive space boundary; and
transmitting a notification to at least one user of the HDDS whenever any hostile devices are detected.
